(19) United States
(12) Patent Application Publication
(10) Pub. No.: US 2014/0279305 A1
(43) Pub. Date: Sep. 18, 2014

(54) OPERATIONAL REPORTING FOR FINANCIAL SYSTEMS

(71) Applicant: ROCKTON SOFTWARE, INC., Sandpoint, ID (US)

(72) Inventors: Guy P. Caron, Great Falls, VA (US); Mark H. Rockwell, Erie, CO (US)

(73) Assignee: ROCKTON SOFTWARE, INC., Sandpoint, ID (US)

(21) Appl. No.: 14/205,985

(22) Filed: Mar. 12, 2014

Related U.S. Application Data
(60) Provisional application No. 61/800,052, filed on Mar. 15, 2013.

(51) Int. Cl. G06Q 40/00

(52) U.S. Cl. CPC G06Q 40/12
USPC 705/30

(57) ABSTRACT

Operational reporting for financial systems is disclosed. In an example, a computer-implemented method is embodied in computer-readable instructions stored on a non-transient computer-readable medium. When executed by a processor, the method includes receiving financial data via any of a plurality of different data entry windows. The method also includes organizing the financial data according to a plurality of segments, each segment identifying at least one attribute of the financial data. The method also includes reporting the financial data via a reporting engine according to any requested attribute by asserting the corresponding segment.

### PRIORITY CLAIM

This application claims the benefit of U.S. Provisional Patent Application No. 61/800,052 filed on Mar. 15, 2013 titled “Operational Reporting For Financial Systems” of Caron and Rockwell, hereby incorporated by reference in its entirety as though fully set forth herein.

### BACKGROUND

Financial systems enable large and small businesses to meet bookkeeping, auditing, and reporting requirements. A typical financial system may be embodied in software and receives data from multiple sources, such as from requisitions, purchase orders (POs), and receiving. The current financial systems rely on a general ledger (GL) approach using “actuals” and “budgets.” Actual revenue and expenditures are recorded and compared with budgeted revenue. But “actuals” are at the time of the expenditure (e.g., sales) or with a small to substantial lag time. The delay in recording and reporting causes a business to look at their financial status after actions have occurred and been recorded.

### BRIEF DESCRIPTION OF THE DRAWINGS

FIG. 1 is a high-level block diagram of an example financial system which may implement operational reporting.

FIG. 2 shows an example architecture to implement operational reporting for financial systems.

FIG. 3 is a flowchart illustrating example operations to implement operational reporting.

### DETAILED DESCRIPTION

Systems and methods are described herein utilizing operational reporting for financial systems. In an example, the systems and methods are implemented with a common document header (CDH) platform. The CDH platform is described briefly herein, but more fully described in co-owned, co-pending U.S. Provisional Patent Application No. 61/677,953 titled “Common document header for financial systems” of Caron, et al. filed on Jul. 31, 2012 and incorporated by reference in its entirety as though fully set forth herein. The systems and methods of operational reporting enable businesses (e.g., managers, accountants, etc.) to have granular insight into the daily operations of an organization by including the budget, operational and financial information.

The structure of financial reporting only allows for a select amount of information to be processed, and typically offers no flexibility (e.g., a financial structure has a fixed length set of information). In an example, a structure may be LL-XXXX-DD, where LL is location, XXXX is the natural GL account as defined by accounting standards, and DD is the department(s) within an organization. The systems and methods described herein enable changing and/or adding additional information without a full restructuring of the accounting GL structure.

Additional information (which is only necessary for subsets of the information) cannot be easily added to the reporting mechanism. In an example, employee expenditures are typically related to travel, entertainment, lodging, vehicle rentals and other specific accounts. Projects may be related to another limited set of accounts. The identification of the employee only belongs to a finite set of accounts. The systems and methods described herein handle all of this information without a separate reporting mechanism being created or the account structure becoming overloaded with all employees in the chart of accounts.

In addition, visibility on activities in the organization is non-existent before the actual occurrence of the activity is reached. Un-posted transactions are available; however any activity leading up to the actual revenues and expenditures are not. On the revenue side an actual sale is often preceded by a multitude of sequential activities, such as Sales Order is itself often the result of a sales quote. Sales quotes are the result of opportunities, leads and even marketing activities. In an example, the purchasing side reports when a requisition (1) for material is started it is deducted from the budget and sits in the requisition bucket. When the PO is issued (2) the committed quantity is increased and the requisitioned quantity is eliminated. Lastly when a PO line item is received (3) completely or partially the amount leaves the committed bucket and moves to the pending bucket. When the invoice is matched (4) and posted in AP, it enters the actual reporting area. The systems and methods described herein make this information visible (e.g., in side-by-side reporting with the actual financials).

Before continuing, it is noted that as used herein, the terms “includes” and “including” mean, but is not limited to, “includes” or “including” and “includes at least” or “including at least.” The term “based on” means “based on” and “based at least in part on.” In addition, the following terms are defined as follows:

Segment. A “segment” (or segments) as used herein is a subset of a General Ledger Account. Segments represent natural groupings in a business for things that generally do not change over time (or do not change substantially). A segment may include the Natural Account segment (to identify Accounts Payable, Accounts Receivable, Cash on Hand, etc.). Segments can also identify entities such as but not limited to, corporate divisions (e.g., corporate divisions do not change frequently over time).

As an example, a General Ledger Account of 10-1200 may be made up of two segments, the first being a corporate division (10=West, 20=Central, 30=East), and the second is the Natural Account segment used in general accounting of Cash. The length of and number of segments varies from company to company, and may even be unlimited. An account of 10-2100-14-3200 might indicate a Division, Natural Account, Location, and Cost Center in a given business practice. Segments represent information about accounts. When transactions occur in the financial system, one or more General Ledger Accounts may be assigned to the transaction through distributions, and the segments on the general ledger accounts provide information about the transaction based on the segment values.

Dimension. A “dimension” (or dimensions) as used herein provides additional information about transactions that are generally not included in segments or in general ledger accounts. Dimensions are used for frequently-changing data. Examples include a Customer or Vendor tied to a transaction, as the customers or vendors a company works with does change over time. Generally, segments are not created in a chart of accounts for customers or vendors. Other example dimensions may include, but are not limited to Projects, Events, Employees, or Equipment.

Attribute. An “attribute” as used herein is derived information about a segment or dimension generally a dimension). For example, if a customer is a dimension, the information about this customer is contained in attributes. Examples of customer attributes may include zip code, country, payment terms, pricing level, or other types of grouping information that might be shared among many customers. When specifying a dimension such as a specific customer, the attributes carry along to reporting to help provide robust information.

FIG. 1 is a high-level block diagram of an example financial system which may implement operational reporting. In an example, a common document header (CDH) platform is utilized for the operational reporting described herein. Operational reporting allows for organizing and reporting on financial data which may be in non-posted and/or non-permanent status. For example, other types of data may include (but is not limited to) Incomplete, Requisitioned, Committed, Pending, and/or Posted aspect, which drives into reporting. The point being that there's tons of financial data that's worth knowing about but isn't “posted”, and typical accounting solutions only show you the “posted” stuff. The systems and methods described herein enable access to posted data and other data.

System 100 may include any of a wide variety of computing devices, such as, but not limited to, stand-alone desktop/laptop/netbook computers, workstations, server computers, blade servers, mobile devices, and appliances (e.g., devices dedicated to providing a financial service), to name only a few examples. Each of the computing devices may include memory, storage, and a degree of data processing capability at least sufficient to manage a communications connection either directly with one another or indirectly (e.g., via a network). At least one of the computing devices is also configured with sufficient processing capability to execute the program code described herein.

In an example, the system 100 may include a hub 110 providing a financial service accessed by a user via a client 120. For purposes of illustration, the financial service may be provided by program code 130 executing on the hub 110 configured as a server computer with computer-readable storage 115. Example services may include general bookkeeping, auditing, and reporting. In an example, the service may be provided in a networked computer system, such as a local area network (LAN), Internet, or cloud-based service. Services may be provided to the client 120 through interfaces to application programming interfaces (APIs) and related support infrastructure provided by various modules or application engines, and/or hosted business services (e.g., online payment systems).

The client 120 may be any suitable computer or computing device capable of accessing the hub 110. Hub 110 and client 120 are not limited to any particular type of devices. Although, it is noted that the operations described herein may be performed by the execution of program code 130 residing on the client, in some instances (e.g., where the client is a tablet or mobile device) the operations may be performed at least in part on a separate computer system having more processing capability, such as a server computer or plurality of server computers on a local area network for the client 120. The computing devices are not limited in function, and may provide other services, such as transaction processing.

The service may include a local and/or remote data source. That is, the data source may be stored local to the service, and/or the source may be physically distributed in the network. The data source may include database facilities for storing data, and applications for providing read/write access to the data. In addition, the data may include unprocessed data, or may undergo at least some level of pre-processing.

The operations described herein may be stored as program code 130 on a non-transient computer readable medium and executed as machine readable instructions by suitable processors or processing devices, such as the components described above with reference to FIG. 1. The machine readable instructions may be self-standing and/or embodied as agents accessed by an existing system.

Example program code 130 used to implement features of the system can be better understood with reference to FIG. 2 and the following discussion of various example functions. However, the operations described herein are not limited to any specific implementation with any particular type of program code.

FIG. 2 shows an example architecture 200 to implement operational reporting for financial systems. In an example, data may be stored according to a CDH platform. The CDH platform allows for common elements to be treated with one set of coding. The CDH platform simplifies the interface, eliminates duplicate processes, and maintains unique data elements. The CDH platform is flexible. New modules or document types may be added, that become native to the end user in the application. If CDH rules are complied with, the reporting module automatically inherits all the data sets and provides for reports, dashboard(s), and data mining. The CDH table provides all core data elements needed for operational, management and fiscal reporting. Posting status can be set by the user, such as in the GL. The posting status may be limited by the interface. A distribution table may store the amount as entered on the original document in debit or credit. The distribution table may store the amount as the base debit or credit based on the currency conversion specified. The distribution table may store default in cash flows.

An example of operational reporting may be implemented using three distinct areas or modules: Budget, Operational and Financial reporting. With budget management interface 214, a budget module 212 allows for tracking of the baseline budget with transactional changes creating the current budget. The available budget is the result of the subtraction of the current budget minus operational and posted activities.

An operations module 220 is comprised of a requisition component 222, a committed component 224 and a pending component 226. Requisition component 222 is designated for addressing requisition documents such as activities in the organization related to sales quote documents 262 or vendor requisition documents 242. An example is budget line is awarded from a project for a value of $20,000. In the budget it might be the procurement of hardware or it might be subset of a larger budget of $150,000 for hardware. Assigning the $20,000 to the purchasing department allows RFQ's to be issued. At the assignment of the monies a requisition amount is created and reduces the available budget. No vendor has been selected yet but visibility of the requisition process is present and allows for proper budget management.

When a vendor 248 is selected and a purchase order 244 is issued, the requisition module 222 can be terminated a purchase order document 244 may be sent by a committed component 224 to a vendor the amount is committed. Purchase order 244 is a document representing a type of binding commitment to purchase services or goods. The commitment is available under the operations module 220 of system 200.

When a customer 268 is selected and a sales order 264 is issued, the requisition module 222 can be terminated a sales order document 264 may be sent by a committed component 224 to a customer the amount is committed. Sales order 244 is a document representing a type of binding commitment to sell services or goods. Committed module is available under the operations module 220 of system 200.

These steps are not visible in typical financial reporting, and separate management reports have to be used to manage budget versus actuals (posted). The operational reporting disclosed herein, enables the pre-actuals (pre-posted) activities to be visible in corporate reporting under the same overall structure.

Financial reporting may include pending transactions and actuals. In an example, the system may include a posted module 232 and a budget available module 234.

When a purchase order line item is received completely or partially the amount leaves the committed component 224 and moves to the pending component 226 and a receiving document 246 is issued. When an invoice 252 is matched and posted by posted component 232 in AP, it is addressed by the financials module 230. At this stage, one or more banks 254 and/or one or more credit cards 256 may be invoked settling payables invoice 252. Budget available component 234 is configured for presenting a budget reflecting posted documents to a reporting interface 270. The systems and methods described herein make this information visible (e.g., in side-by-side reporting with the actual financials).

When a sales order line item is received completely or partially the amount leaves the committed component 224 and moves to the pending component 226. When a sales invoice 266 is matched and posted by posted component 232 in AP, it is addressed by the financials module 230. Budget available component 234 is configured for presenting a budget reflecting posted documents to a reporting interface 270. The systems and methods described herein make this information visible (e.g., in side-by-side reporting with the actual financials).

Pending transactions, handled by pending module 226, are typically transactions that are not approved by the finance department to be included in financial statement. Actuals are posted transactions and may be used for financial reporting. The operation reporting disclosed herein enables management to have insights into the daily operations of an organization by including the budget, operational and financial information.

At each document 242, 244, 246, 252, 262, 264 and 266, additional information can be required to supplement the system with other data sets that may be desired or useful to the organization. The additional information can be automatically derived with static information related to the item, and/or supplied by the operator at the time of the transaction. A derived transaction can be the line of business which is an attribute of the SKU or line item being sold. A transactional item can be an employee ID when an expense receipt is processed. Oftentimes, these are referred to as dimensions or dimensional analysis.

Operational reporting can be implemented by the reporting engine. In an example, operational reporting uses Common Document Headers (CDH). A document type can be associated with one or many reporting status, such as but not limited to: (i) Requisition, (ii) Committed, (iii) Pending, and (iv) Posted. In an example, Items i, ii and iii can be considered part of the operational reporting elements and can be programmed to be inserted in the proper “buckets” depending on the status of the document.

A document can also be considered “incomplete” or “completed.” An incomplete designator means that there is not sufficient data to be able to include the document as a reliable source of data for the reporting mechanism, and therefore such document would no longer show up in the reporting mechanism. Although documents with both incomplete and complete designators can be included in reports, documents with “incomplete” designators are generally not included in the operational part of the system. For example, in ‘Budget—Requisition—Committed—Pending—Posted=Budget available,’ the documents with an incomplete designation can be included but do not influence the Available budget.

For purposes of illustration, GL segment may be expressed as LL-XXXX-DD, where LL represents a location, XXXX represents an account, and DD represents a division within an organization, can be split into:
a. LL
b. XXXX
c. DD

An analysis server is used to create pivot tables where each segment is treated as a dimension. This allows sorting and grouping of the segments in any order. The segments are automatically passed to the reporting engine as “buckets” illustrated by the following combinations/sub-combinations.

LL

XXXX

DD

LL

DD

XXXX

DD

LL

XXXX

DD

XXXX

LL

LL

DD

XXXX

LL

XXXX

DD

Any number of segments may be used, and is not limited to the three segments shown in this illustration. It is noted that there are more combinations if more segments are used (and fewer combinations if fewer segments are used).

In addition, other data sets may be included such that each main record can be added to each dimension, with its own set of attributes. For purposes of illustration, segments and attributes may include but are not limited to:

a. Customer (Region, Type)

b. Vendor (Type, State)

c. Item (Line of Business, Type, etc.)

d. Account (Segment, Legacy Account, etc. . . . )

It is noted that additional information can also be included for a transaction, project, employee code (and/or other field), and included in the reporting mechanism as described above. Additional information can also be added to existing main records. Both types can be selected to be added to the reporting mechanism (e.g., offering many ways to analyze the data from budget to Operational and Actual financials).

Before continuing, it should be noted that the examples described above are provided for purposes of illustration, and are not intended to be limiting. Other devices and/or device configurations may be utilized to carry out the operations described herein.

FIG. 3 is a flowchart illustrating example operations which may implement operational reporting. Operations 300 may be embodied as logic instructions on one or more computer-readable medium. When executed on a processor, the logic instructions cause a general purpose computing device to be programmed as a special-purpose machine that implements the described operations. In an example, the components and connections depicted in the figures may be used.

Example operation 310 includes receiving financial data via any of a plurality of different data entry windows. Example operation 320 includes organizing the financial data according to a plurality of segments and/or dimensions, each segment and/or dimension identifying at least one attribute of the financial data. In an example, the segments may include standard be applied to the segments to further categorize the financial data. Example operation 330 includes reporting the financial data via a reporting engine according to any requested attribute by asserting the corresponding segment and/or dimension.

The operations shown and described herein are provided to illustrate example implementations. It is noted that the operations are not limited to the ordering shown. Still other operations may also be implemented.

In an example, operations may also include organizing the financial data in a common document header (CDH). Operations may also include organizing the financial data according to a hierarchy based on the segments. Operations may also include filtering the financial data according to the segments. Operations may also include ranking the financial data according to the segments.

The operations may be implemented at least in part using an end-user interface, including but not limited to a web-based interface. Various of the operations described herein may be automated or partially automated. For example, the end-user may make selections via the user interface which result in one or more of the operations described above being executed.

In an example use case, operational reporting may be used with a law firm (or other service provider) financial system. It is noted however, that this example use case is provided only for purposes of illustration, and is not intended to be limiting. The operational reporting systems and methods described herein may be utilized with any financial system in any industry or industries.

In this example, an account structure may identify law firm partners by the segment DD (e.g., the partner is considered a department in this illustration). All expenses and revenues input to the financial system for a particular partner may be associated with a segment identifier (e.g., DD=01). Accordingly, when a report is run to check the financials of a particular partner (e.g., DD=01), this is referred to herein as “operational reporting” wherein out of all financial data for a particular law firm, specific reports (e.g., budget, billables, costs, etc.) can be in the financial system associated with the segment DD=01. The financial data may also be reported with respect to time (e.g., on a quarterly, semi-annual, annual, or multi-year basis).

The segments enable data fields to be readily transferred from a database for the financial system, to a processing queue for dynamic report generation. Any type and/or number of reports can be readily generated, modified, refined, and/or re-generated, by asserting the segments during report generation.

In an example, different levels of granularity may also be accessed using further segments (e.g., financials for a particular client of the law firm partner, an associate attorney working under the law firm partner, charges for a particular trip, income from a particular geographic area, etc.). That is, a different segment may be assigned for financial data according to any of these and/or other metrics, and then used to generate specific reports by sorting and outputting the financial data associated with the desired segment(s). Any segments can be added, removed, configured (and reconfigured), and/or customized.

In an example, the segments may include standard (or predefined) segments, custom-defined segments, and/or derived segments. Derived segments may “flow” from other segments. For example, if the partner DD=01 is based in California, then financial data entered into the financial system for partner DD=01 may automatically include a location segment (e.g., LL=CA), and therefore the location data “flows” from the partner segment. In another example, a separate segment is not needed, if DD=01 is identified as being in California.

In an example, the segments enable the flexibility to move in a hierarchy when managing financial data in the financial system. For example, where financial data includes the segments for law firm location (LL), law firm partner (DD), and client account (XXXX), a report can be generated for all expenses for a particular law firm partner by asserting DD for the partner of interest. This report may include all financial data (client accounts XXXX and law firm locations LL) for the partner (e.g., DD=01). Another report can be generated for all expenses for a particular law firm location by asserting LL for the location of interest. This report may include all financial data (client accounts XXXX and law firm partners DD) for the location (e.g., LL=01). Another report can be generated for all expenses associated with a particular client (regardless of partner and/or location) by asserting LL for the location of interest. This report may include all financial data (locations LL and law firm partners DD) for the client (e.g., client accounts XXXX=0101). Any of these reports can then be refined, for example, by first sorting by law firm partner (DD=01), and then for all expenses generated by that law firm partner (DD=01) at a particular office location (e.g., LL=01), and then for all clients served at that office location. Any combination/sub-combination can be asserted to generate the desired report(s).

It is noted that the examples shown and described are provided for purposes of illustration and are not intended to be limiting. Still other examples are also contemplated.

1. A computer-implemented method embodied in computer-readable instructions stored on a non-transient computer-readable medium, when executed by a processor the method comprises:
receiving financial data via any of a plurality of different data entry windows;
organizing the financial data according to a plurality of segments or dimensions, each segment or dimension identifying at least one attribute of the financial data; and
reporting the financial data via a reporting engine according to any requested attribute by asserting the corresponding segment or dimension.

2. The method of claim 1, further comprising organizing the financial data in a common document header (CDH).

3. The method of claim 1, further comprising organizing the financial data according to a hierarchy based on the segments or dimensions.

4. The method of claim 1, further comprising adding one or more custom segments or dimensions.

5. The method of claim 1, further comprising applying attributes to the segments or dimension to further categorize the financial data.

6. The method of claim 1, further comprising filtering the financial data according to the segments or dimensions.

7. The method of claim 1, further comprising ranking the financial data according to the segments or dimensions.

8. The method of claim 1, further comprising derived segments or derived dimensions.

9. A system comprising:
a datastore for financial data received via any of a plurality of different data entry points;
program code stored on a non-transient computer-readable medium and executable by a processor to:
organize the financial data according to a plurality of segments or dimensions, each segment or dimension identifying at least one attribute of the financial data; and
report the financial data via a reporting engine according to any requested attribute by asserting the corresponding segment or dimension or dimension.

10. The system of claim 9, wherein the financial data is organized in a common document header (CDH).

11. The system of claim 9, wherein the financial data is organized according to a hierarchy based on the segments or dimensions.

12. The system of claim 9, further comprising custom segments or dimension.

13. The system of claim 9, further comprising attributes for the segments or dimensions to further categorize the financial data.

14. The system of claim 9, further comprising executing the processor to filter the financial data according to the segments or dimensions.

15. The system of claim 9, further comprising executing the processor to rank the financial data according to the segments or dimensions.

16. The system of claim 9, wherein the segments or dimensions include derived segments or dimensions.

17. A computer program product including computer-readable instructions stored on a non-transient computer-readable medium executable by a processor for operational reporting for financial systems comprising:
receive financial data via any of a plurality of different data entry points;
organize the financial data according to a plurality of segments or dimensions, each segment or dimension identifying at least one attribute of the financial data; and
report the financial data via a reporting engine according to any requested attribute by asserting the corresponding segment or dimension.

18. The computer program product of claim 17, wherein the financial data is organized in a common document header (CDH).

19. The computer program product of claim 17, wherein the computer-readable instructions are executable to organize the financial data according to a hierarchy based on the segments or dimensions.

20. The computer program product of claim 17, wherein the computer-readable instructions are executable to add custom segments or dimensions.
